(19) United States
(12) Patent Application Publication
(10) Pub. No.: US 2016/0207014 A1
(43) Pub. Date: Jul. 21, 2016

(54) High Efficiency Truck Mounted TMR Mixer

(71) Applicant: Farm Aid Equipment, Inc., Corsica, SD (US)

(72) Inventor: Lance C. Onan, Corsica, SD (US)

(73) Assignee: Farm Aid Equipment, Inc.

(21) Appl. No.: 14/599,726

(22) Filed: Jan. 19, 2015

(51) Int. Cl. B01F 7/00; B01F 3/18; B01F 15/02

(52) U.S. Cl. CPC B01F 7/00433; B01F 15/0267; B01F 3/18; B01F 15/0288

(57) ABSTRACT

A high efficiency truck mounted TMR mixer for mixing ingredients. The high efficiency truck mounted TMR mixer generally includes a mixing tank configured to be mounted on a frame of a truck. A reel disposed inside the mixing tank and for mixing ingredients within the mixing tank. The reel includes a first helical blade continuously extending along a length of a first portion of the reel, and a second helical blade continuously extending along a length of a second portion of the reel. The first portion and said second portion are longitudinally offset from one another along the reel.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a mixing device and more specifically it relates to a high efficiency truck mounted TMR mixer for mixing agricultural ingredients, such as feed.

2. Description of the Related Art

Any discussion of the related art throughout the specification should in no way be considered as an admission that such related art is widely known or forms part of common general knowledge in the field.

Typically, mixing devices, such as total mixed ration (TMR) mixers, require around 100 horsepower to operate (e.g., rotate reels, augers, etc.). Moreover, such mixing devices operate while moving at a slow rate of speed (e.g., 2-3 mph).

Conventional trucks, set up for road use, are typically geared such that when travelling at a low rate of speed (e.g., 2-3 mph), they do not have superfluous horsepower to properly power a mixing device. Accordingly, conventional trucks are modified with a lower gear ratio to provide superfluous horsepower to run a mixing device that requires approximately 100 horsepower to operate.

Moreover, temporarily slowing down a conventional truck with an automatic transmission is difficult when the engine speed is high enough to provide the superfluous power to run the mixer and propel the truck. In order to provide requisite power to propel the truck, at a low speed, and also provide the superfluous power to operate the mixing device, the truck must be modified with an additional transmission or gear reduction device. As a result, the cost, time and difficulty of operating the mixer is increased due to the modification of the truck to provide the requisite horsepower to propel the truck and to operate the mixer.

Because of the inherent problems with the related art, there is a need for a new design incorporating a high efficiency TMR mixer mounted on a truck, a hydraulic control device, and an automatic transmission and a “live” PTO that can provide the requisite horsepower without requiring modification to the truck to increase superfluous horsepower.

### BRIEF SUMMARY OF THE INVENTION

The invention generally relates to a hydraulically powered mixing device which includes a mixing tank configured to be mounted on a frame of a truck. A hydraulic pump is driven by a PTO mounted to an automatic transmission with a “live” PTO. This combination of design elements decreases the capital investment of the truck mounted PTO, decreases the operating costs, and makes the distribution of the mixed ingredients significantly easier.

Alternatively, the hydraulic pump could be driven by a separate engine mounted on the truck frame.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention.

FIG. 3 is an upper perspective view of the present invention.

FIG. 4 is a side perspective view of the present invention.

FIG. 5 is a side perspective view of the present invention.

FIG. 6 is a side perspective view of the present invention.

FIG. 7 is a top perspective view of the present invention.

FIG. 8 is a top perspective view of the present invention.

FIG. 9 is a back perspective view of the present invention.

FIG. 10 is a side perspective view of the present invention.

FIG. 11 is a back perspective view of the present invention.

FIG. 12 is an upper perspective of a control interface of the present invention.

FIG. 13 is a block diagram of the hydraulic system of the present invention.

### DETAILED DESCRIPTION OF THE INVENTION

### A. Overview.

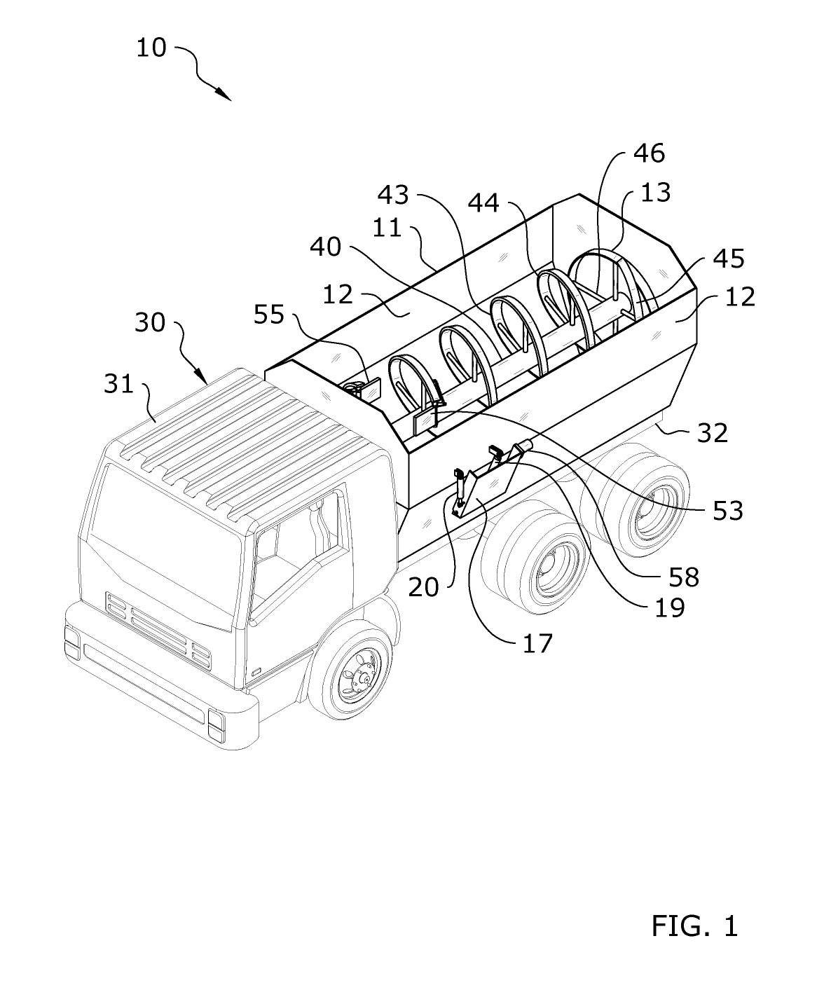

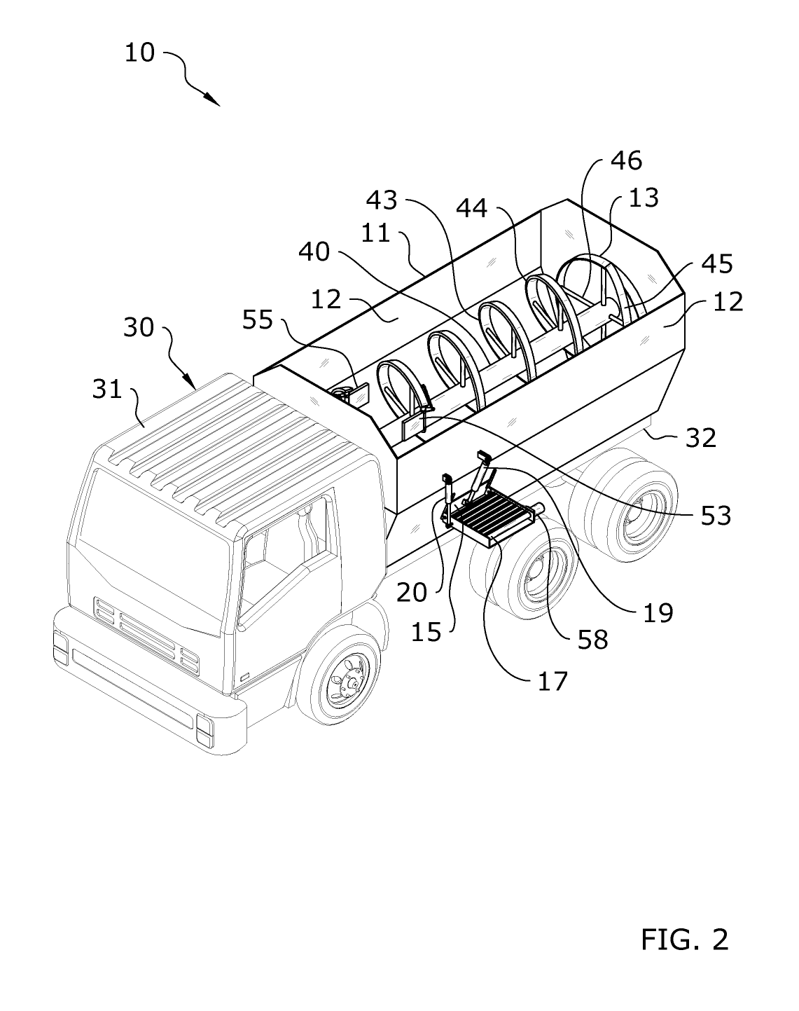

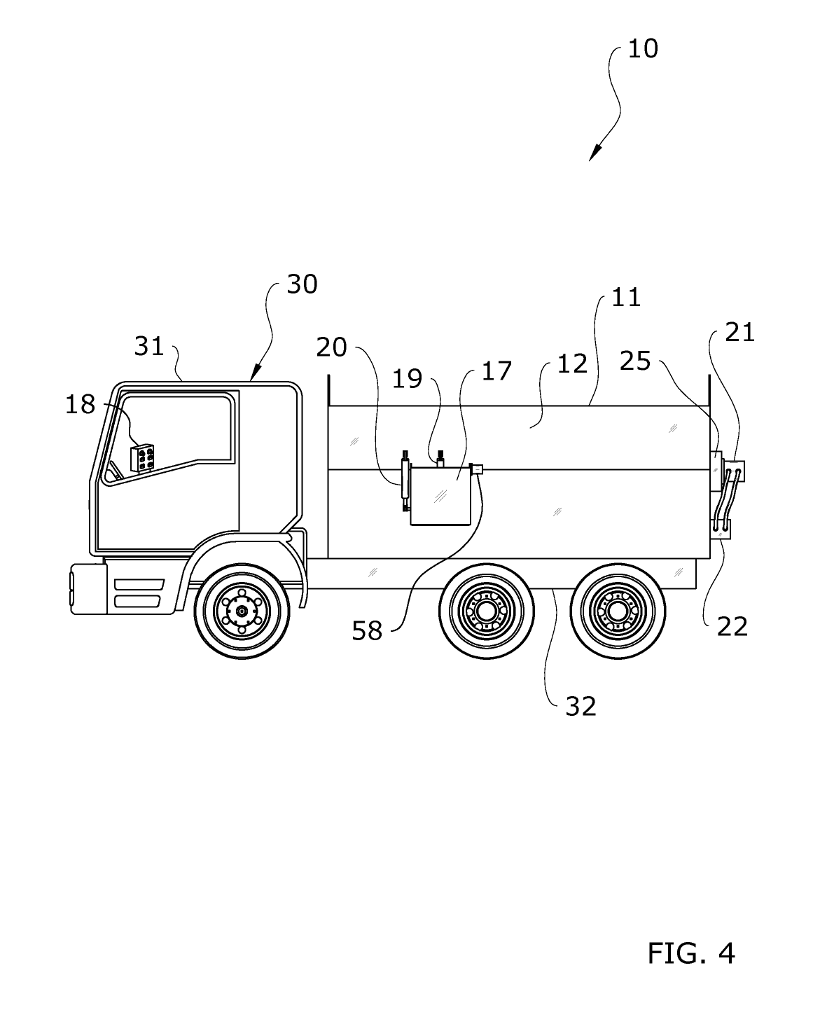

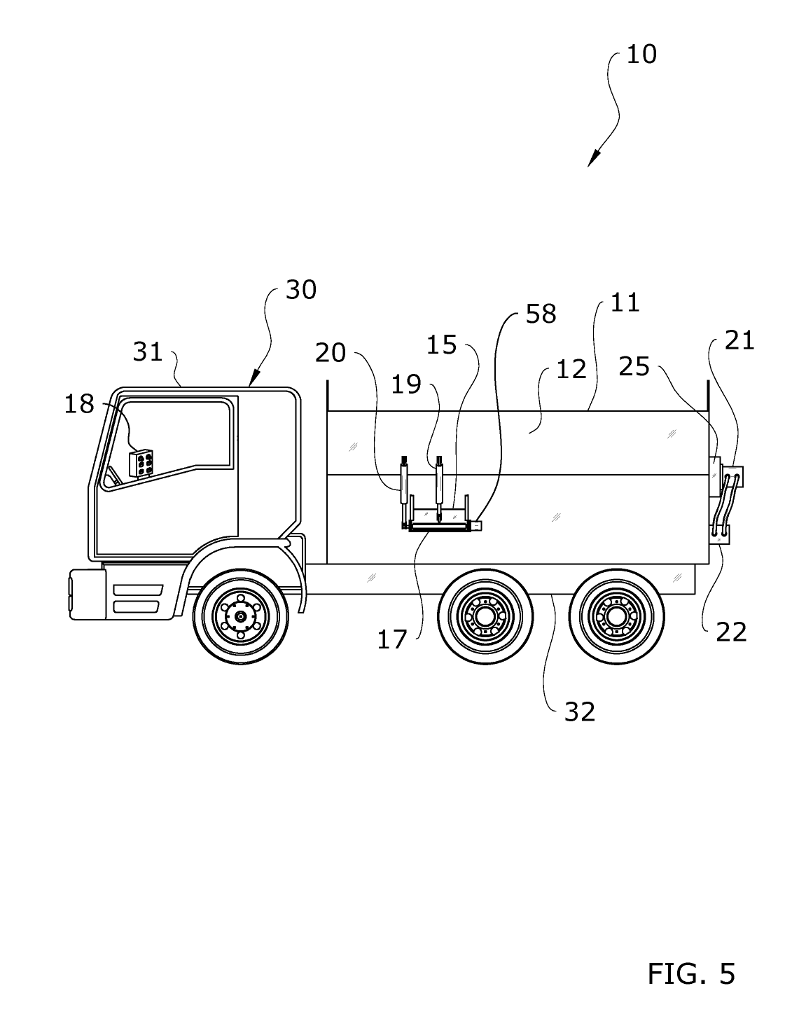

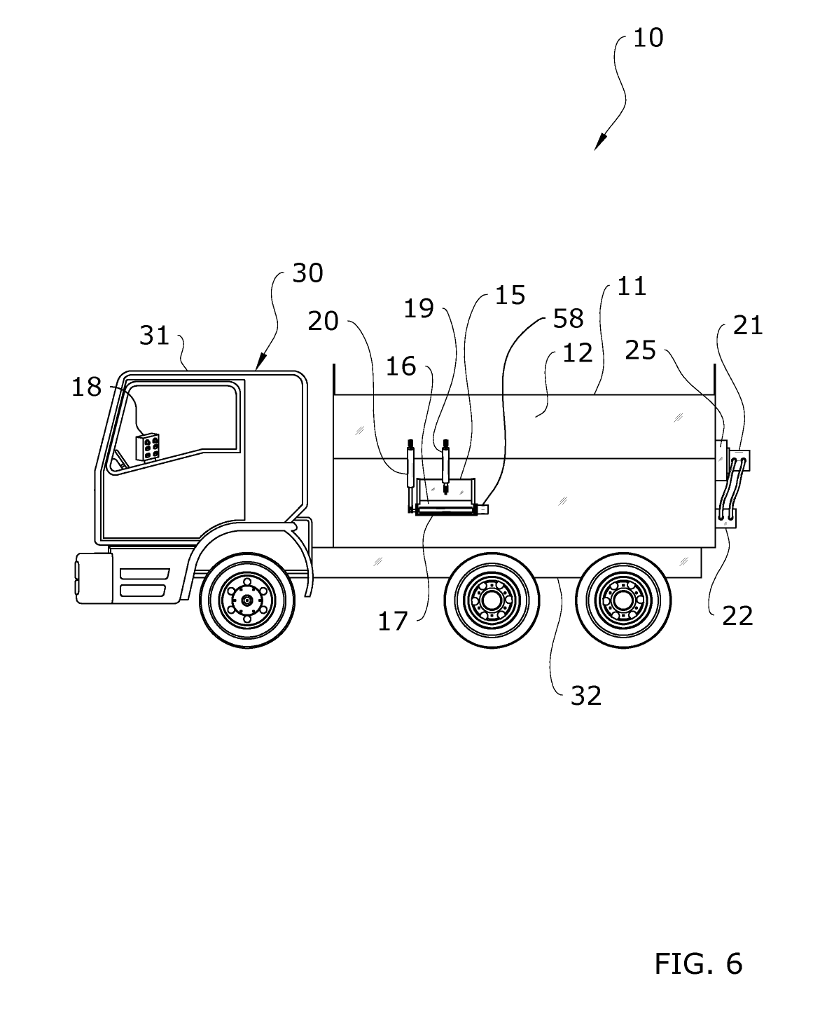

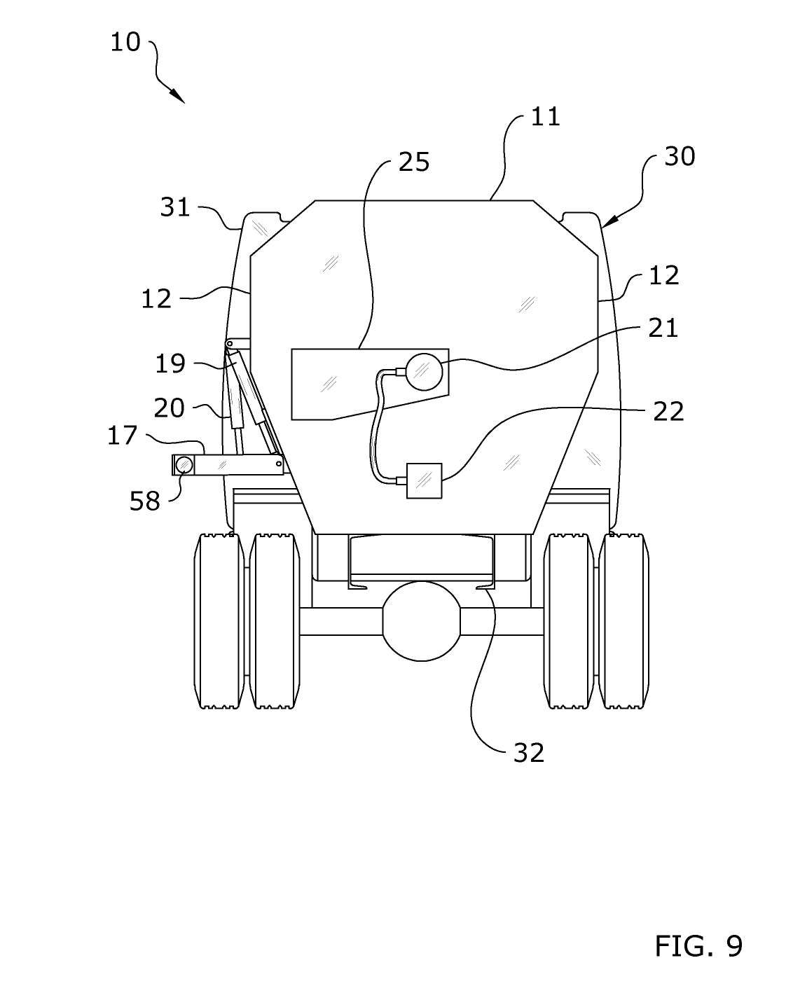

Turning now descriptively to the drawings, in which similar reference characters denote similar elements throughout the several views, FIGS. 1 through 13 illustrate embodiments of a high efficiency truck mounted TMR mixer 10 (also referred herein as mixer or mixing device), which comprises, among other things, mixing tank 11, walls 12, reel 13, auger 14, door 15, opening 16, conveyor 17, control interface 18, hydraulic actuator 19, hydraulic actuator 20, hydraulic motor 21, and hydraulic control valve 22.

Additionally, as described herein, mixing device 10 is mounted onto truck 30. Truck 30, includes among other things, cab 31, frame 32, engine 33, power take-off (PTO) 34, automatic transmission 36 and hydraulic pump 35.

Mixing device 10, in one embodiment, is mounted to frame 32 of truck 30 and is hydraulically driven via hydraulic pressure provided by hydraulic pump 35 driven by a power take-off 34 of truck 30.

As will be described in further detail below, mixing device 10 is a high-efficiency mixing device. That is, mixing device 10 operates or is fully functional with a provided horsepower (e.g., 30 horsepower) that is lower than the horsepower required for operating conventional mixing devices. The high-efficiency nature of the mixing device is due, in part, to the structure and functionality of reel 13.

### B. Mixing Device

Mixing device 10 is a device for mixing ingredients 26. Mixing device 10 can be but is not limited to a total mixed ration (TMR) mixer, reel-type mixer, etc. Mixing device 10 can mix various types of ingredients 26. In various embodiments, the ingredients are agricultural ingredients for feeding livestock. Ingredients can include, but are not limited to, roughage (e.g., hay), grain, etc.

### C. Mixing Tank

Mixing tank 11 is a tank that contains ingredients 26 that are to be mixed by the mixing device. Mixing tank 11 includes walls 12 that form the tank. Reel 13 and auger 14 are disposed within mixing tank 11 for at least mixing ingredients within mixing tank 11.

### D. Reel and Auger

In general, the combination of reel 13 and auger 14 are for mixing ingredients 26 within mixing tank 11. Reel 13 and auger 14 are hydraulically powered such that they rotate within mixing tank 11. As a result, ingredients 26 within mixing tank 11 are mixed together via reel 13 and auger 14. In one embodiment, mixing device 10 includes only a single reel.

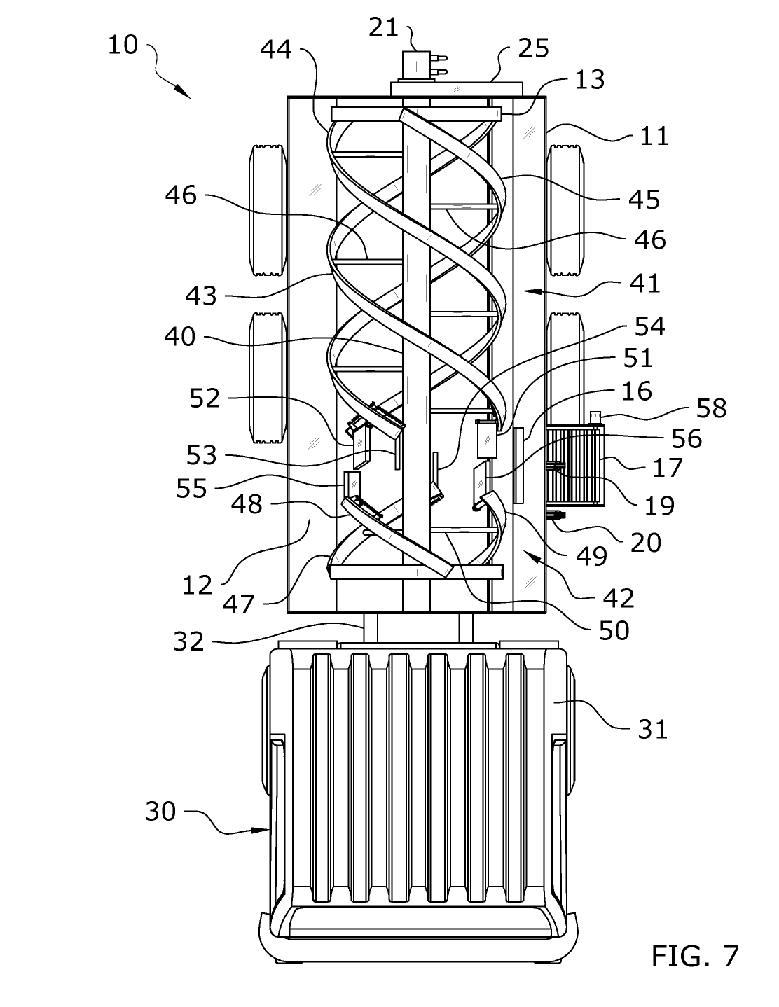

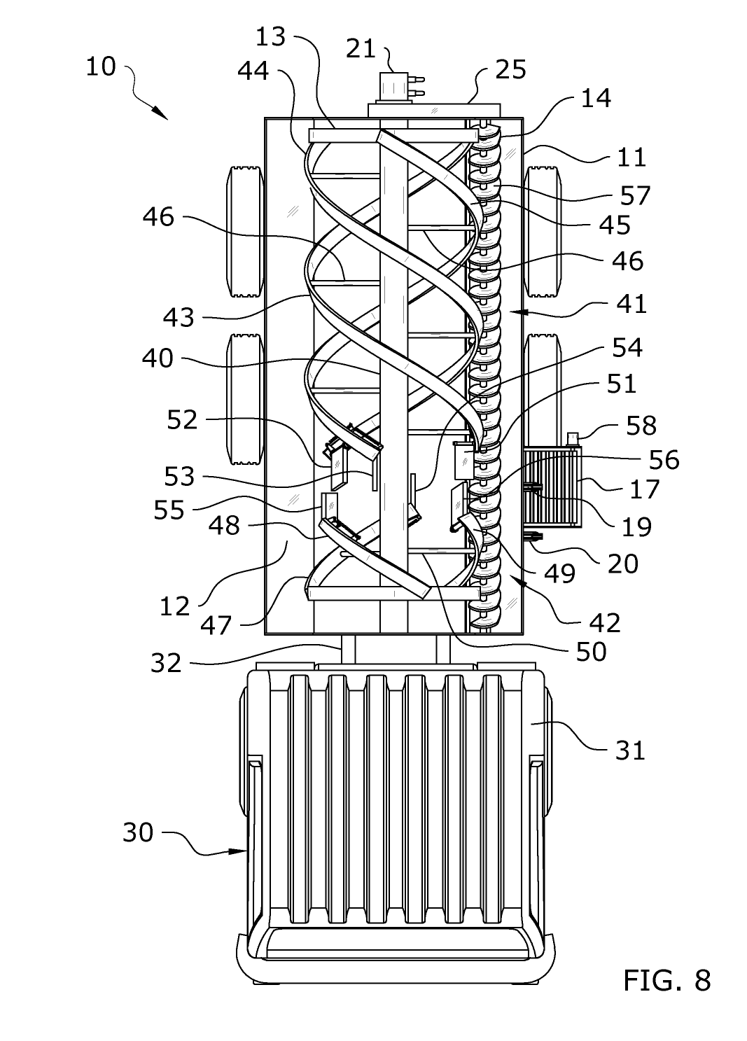

Referring now to at least FIG. 7 (which excludes auger 14 for clarity) and FIG. 8, reel 13 is a horizontal reel and includes axle 40 that extends an entire length of reel 13. Reel 13 rotates within mixing tank 11 as axle 40 rotates.

Reel 13 includes a first portion 41 and second portion 42. First portion 41 extends from the back of the mixing device to opening 16 (or near the middle of opening 16). Second portion 42 extends from the front of mixing device to opening 16 (or near the middle of opening 16). Accordingly, first portion 41 and second portion 42 meet at opening 16 (or near the middle of opening 16).

Moreover, first portion 41 and second portion 42 are off-set from one another with respect to the longitudinal axis (or axle 40) of reel 13. As such, blades and paddles of first portion 41 are also off-set from the blades and paddles of second portion 42 with respect to the longitudinal axis (or axle 40) of reel 13

First portion 41 includes blade 43, blade 44 and blade 45 that are configured for mixing the ingredients within mixing tank 11. In some embodiments, blades 43, 44 and 45 cut the ingredients such as hay.

Blades 43, 44 and 45 extend helically and continuously along the length of first portion 41. Blades 43, 44 and 45 are supported by supports 46 that extend radially from axle 40. As a result, blades 43, 44 and 45 are not directly connected to from axle 40.

It should be appreciated that first portion 41 includes at least one blade. However, first portion can include a plurality of blades that extend helically and continuously along the first portion.

Second portion 42 includes blade 47, blade 48 and blade 49 that are configured for mixing ingredients within mixing tank 11. In some embodiments, blades 47, 48 and 49 cut the ingredients such as hay.

Blades 47, 48 and 49 extend helically and continuously along the length of second portion 42. Blades 47, 48 and 49 are supported by supports 50 that extend radially from axle 40. As a result, blades 47, 48 and 49 are not directly connected to axle 40.

Blades 47, 48 and 49 of second portion 42 rotate coaxially with blades 43, 44, and 45 of first portion 41 because each of the blades are connected to axle 40 via supports 50 and 46, respectively, that radially extend from axle 40. However, blades 47, 48 and 49 are separate from blades 43, 44 and 45.

Each of the blades of reel 13 includes a paddle at the end that is proximate opening 16. For example, blade 43 includes paddle 51, blade 44 includes paddle 52, blade 45, includes paddle 53, blade 47 includes paddle 54, blade 48 includes paddle 55, and blade 49 includes paddle 56.

As reel 13 rotates within mixing tank 11, each of the paddles also rotates within mixing tank 11. As the paddles translate along the inside wall of mixing tank 11, they pass along opening 16. When door 15 is open, the paddles push ingredients out through opening 16 as they pass by opening 16. In particular, each paddle pushes ingredients out of opening 16 onto conveyor 17 as each paddle passes by opening 16.

As reel 13 rotates within mixing tank 11, ingredients 26 are mixed within mixing tank 11. Additionally, ingredients are moved in the direction from back to front of mixing tank 11 as reel 13 rotates due to the helical nature of the blades of reel 13. In order to off-set or reduce the build-up of ingredients towards the front of mixing tank 11, auger 14 rotates to move the ingredients from the front of mixing tank 11 towards the back of mixing tank 11.

Auger 14 (as depicted in at least FIG. 8) is disposed along an inside wall of mixing tank 11. In addition to moving the ingredients towards the back of mixing tank 11, auger 14 (in combination of reel 13) facilitates in mixing the ingredients by reel 13 within mixing tank 11.

Auger 14 includes blade 57 that is directly attached to the axle of auger 14. Blade 57 extends helically and continuously along the length of auger 14. In one embodiment, mixing device 10 includes only a single auger. In another embodiment, mixing device 10 can include more than one auger. For example, two or more augers may be disposed within mixing tank 11 to facilitate in mixing the ingredients and moving the ingredients towards the back of mixing tank 11.

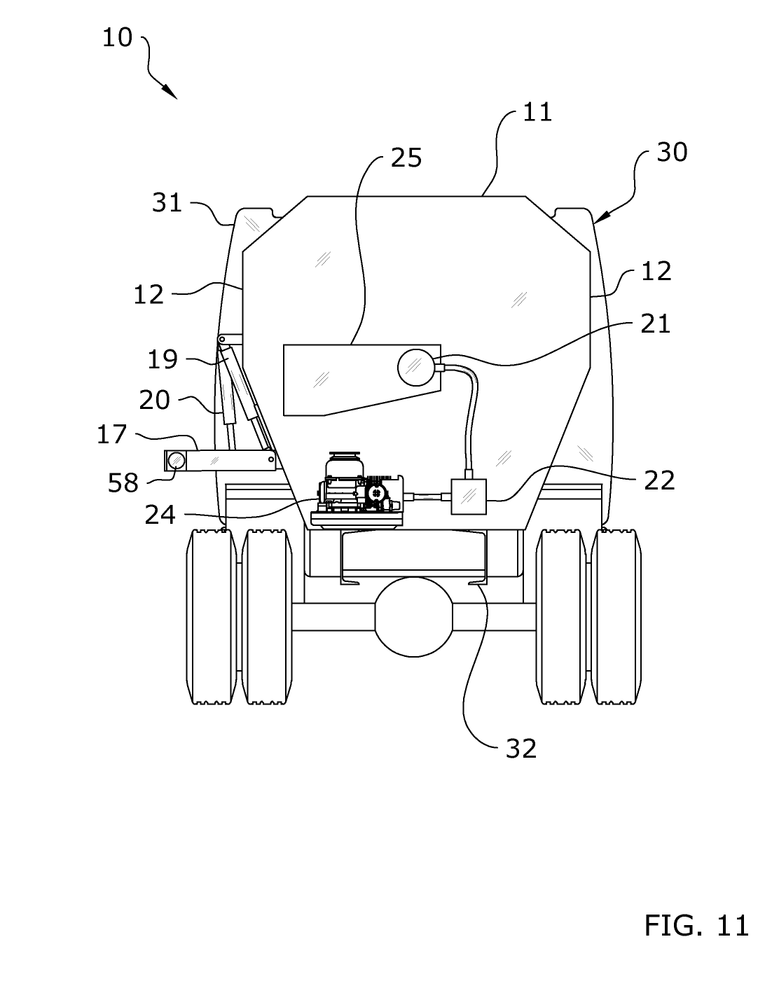

In one embodiment, mixing device 10 includes oil bath 25, as depicted in FIG. 11. Oil bath 25 is for lubrication/protection of the chain that drives auger 14.

### E. Door

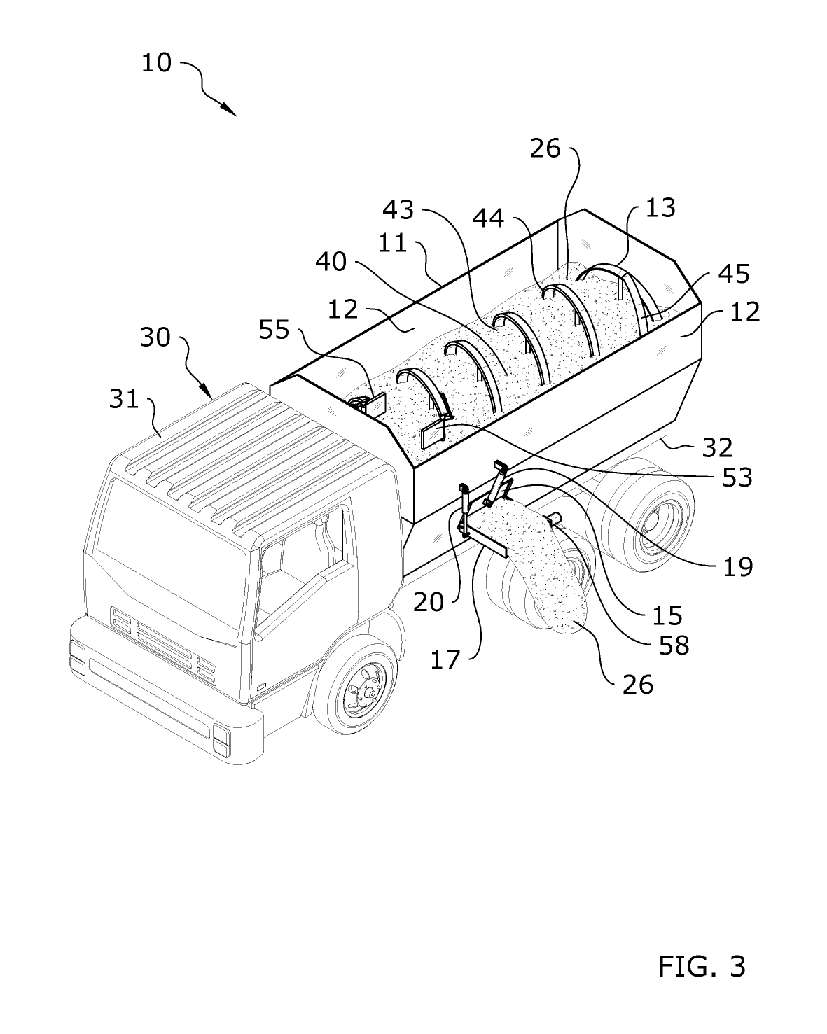

Door 15 regulates the outflow of the ingredients through opening 16. For example, when door 15 closes, opening 16 is closed and there no outflow of ingredients. When door 15 is opened then opening 16 is opened and ingredients flow out of mixing tank 11 through opening 16 (as depicted in at least FIG. 3). The ingredients flow through opening 16 onto conveyor 17 as a result of the paddles within mixing tank 11 pushing out the ingredients through opening 16.

It should be appreciated that door 15 is hydraulically powered. For example, door 15 is translated in an open and closed position via hydraulic actuator 19.

### F. Conveyor

Conveyor 17 conveys the ingredients away from mixing tank 11. For example, the ingredients flowing out of opening 16 fall onto conveyor 17 which then moves the ingredients away from mixing tank 11 (as depicted in at least FIG. 3). For example, conveyor 17 conveys the ingredients into a feed trough.

It should be appreciated that conveyor is hydraulically powered. In one embodiment, the height of conveyor 17 is adjusted via hydraulic actuator 20. In other words, conveyor 17 is adjusted up or down via hydraulic actuator 20.

In another embodiment, a discharge chain drives the conveyor belt of conveyor 17. The discharge chain is powered by hydraulic motor 58 which may be attached to conveyor 17.

### G. Hydraulic System

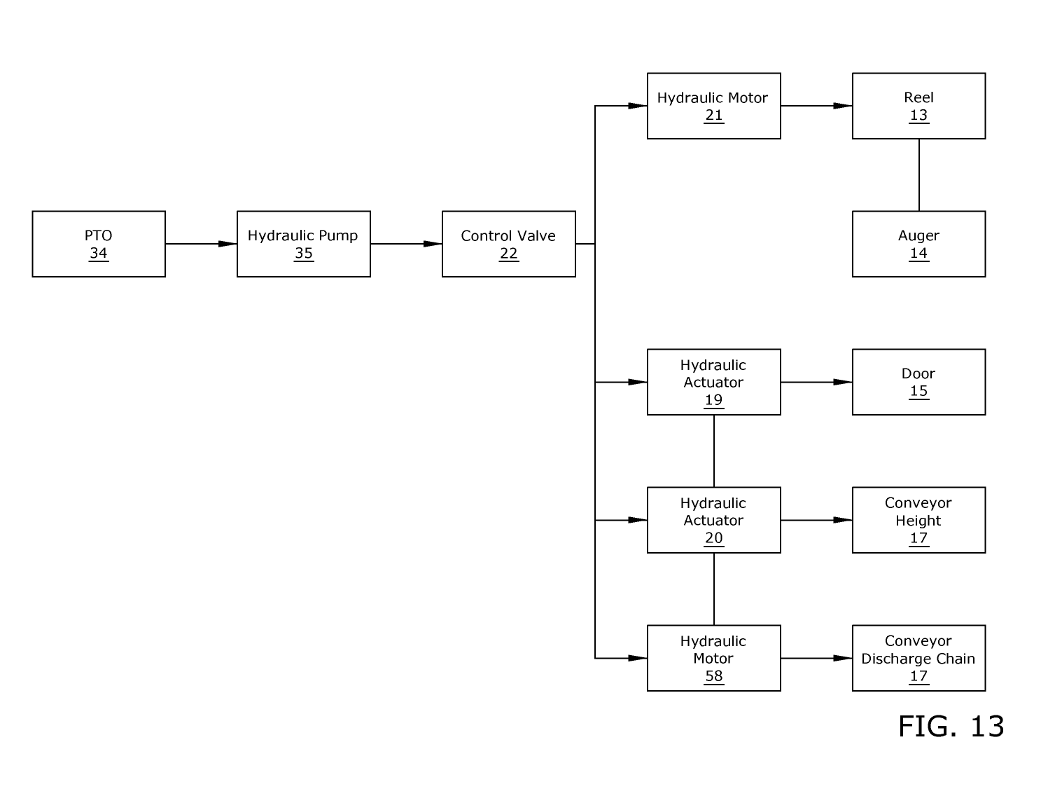

FIG. 13 depicts an embodiment of a block diagram of the hydraulic system for powering mixing device 10. For example, the hydraulic system includes hydraulic pump 35 that is powered by PTO 34, wherein PTO 34 is attached to an automatic transmission 36 of engine 33 of truck 30. Engine 33 of truck 30 provides the requisite horsepower for hydraulically powering mixing device 10.

Alternatively, stationary engine 24 could provide the rotational mechanical force to the hydraulic pump 35, as depicted in at least FIG. 11.

The rotation of PTO 34 drives hydraulic pump 35. The hydraulic pump uses the rotational mechanical force of the PTO to pressurize the hydraulic fluid within the hydraulic system. Hydraulic pump 35, in one embodiment, is a hydraulic load sensing pump.

The pressurized hydraulic fluid is then utilized by mixing device 10 to drive at least reel 13, auger 14, hydraulic actuator 19, hydraulic actuator 20, and the discharge chain of conveyor 17.

In one embodiment, hydraulic motor 21 of mixing device 10 uses the pressurized hydraulic fluid to apply a mechanical force to drive reel 13 and auger 14. In another embodiment, hydraulic motor 58 uses the pressurized hydraulic fluid to apply a mechanical force to drive the discharge chain of conveyor 17 such that the conveyor belt of conveyor 17 translates the ingredients away from mixing tank 11.

In another embodiment, hydraulic system includes hydraulic control valve 22 for controlling hydraulic functions of mixing device 10. For example, in response to control signals, control valve 22 provides hydraulic pressure to hydraulic motor 21 such that reel 13 and auger 14 rotate within mixing tank 11.

Control valve 22 also provides hydraulic pressure to hydraulic actuators 19 and 20 to actuate door 15 and conveyor 17, respectively. Control valve 22 may be an electric over oil control valve.

The hydraulic system of the mixing device provides various advantages as compared to conventional mixing systems. For example, the hydraulic system, in particular, PTO 34 and hydraulic pump 35, eliminates any coupling of the truck engine speed and the mixer speed. The control valve also may modulate the pump to prevent unneeded hydraulic power.

### H. Truck

Truck 30 can be any vehicle that includes a frame (e.g., frame 32) such that mixing device 10 is able be mounted to the frame. Truck 30 can be, but is not limited to, a box truck, straight truck, etc.

Truck 30 includes engine 33 that provides the requisite horsepower to hydraulically drive mixing device 10. In one embodiment, engine 33 provides the requisite horse power such that truck 30 can be propelled forward and additional horsepower (e.g., 30 horsepower) to hydraulically drive mixing device 10.

For example, while truck is driving 4 mph, engine 33 is running at 1,000 rpm. Additionally, there is enough slip in an automatic transmission of engine 33 that the speed can be modulated with application of brakes. As such, engine 33 provides the requisite horsepower to hydraulically operate mixing device 10.

In various embodiments, truck 30 is a conventional road driving truck that includes a conventional automatic transmission 36 with a “live” PTO and final drive gearing for normal road use. For example, truck 30 is not required to be modified to provide the requisite superfluous horsepower to drive mixing device 10 while operating at a low rate of speed.

Truck 30, in some embodiments, may be modified to facilitate the mounting and functioning of mixing device 10. For example, truck 30 may be modified with a different radiator and/or front bumper. In particular, truck 30 may be modified such that hydraulic pump 35 is mounted on the front bumper of truck 30.

### I. Control Interface

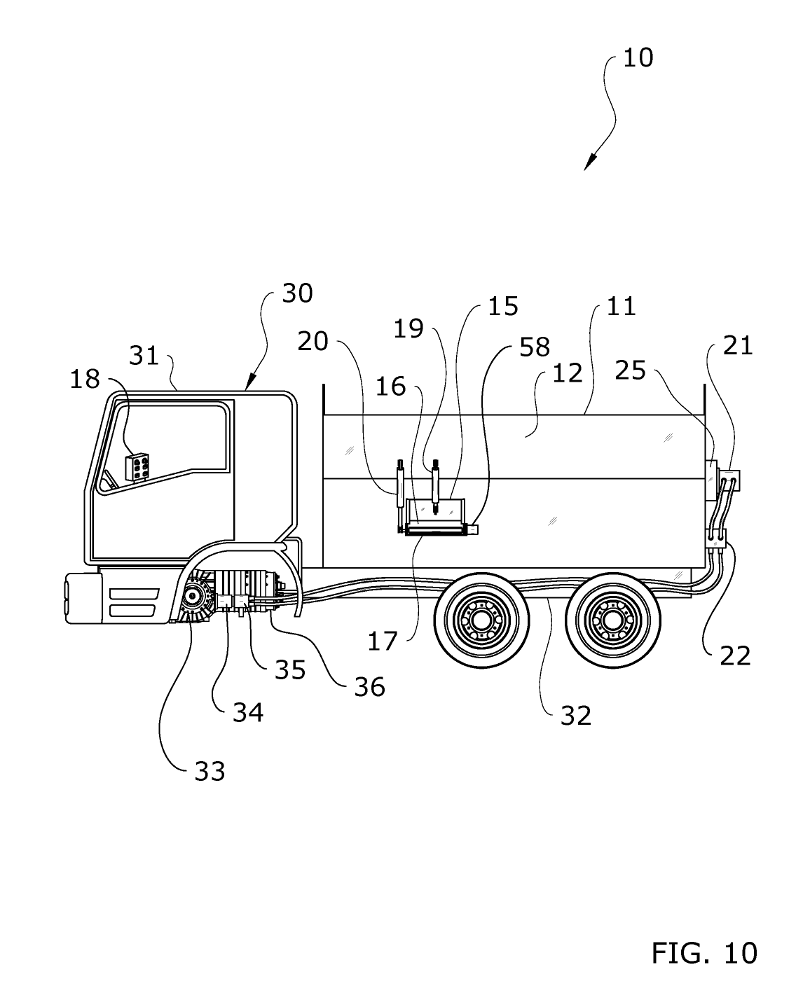

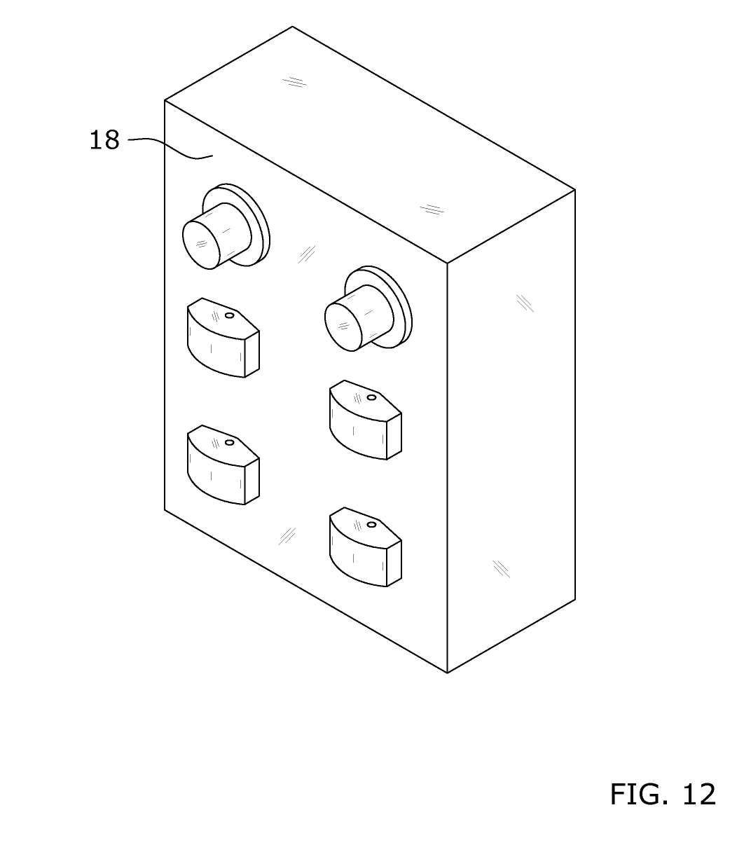

Referring to at least FIGS. 10 and 12, mixing device 10 includes control interface 18 that is disposed in cab 31 of truck 30 such that the driver of truck 30 is able to control mixing device 10 while driving truck 30. More specifically, control interface 18 is an interface of an electrically operated hydraulic control system for controlling mixing device 10.

In one embodiment, control interface 18 enables control of at least, on/off of conveyor 17, speed of the conveyor belt of conveyor 17, up/down (i.e., height) of conveyor 17, rotational speed of reel 13, on/off of reel 13 and open/close of door 15.

### J. Operation of Preferred Embodiment.

In use, engine 33 of truck 30 drives PTO 34 which subsequently drives hydraulic pump 35. Hydraulic pump 35 then pressurizes hydraulic fluid in the hydraulic system.

Mixing device 10 receives the pressurized hydraulic fluid to operate, as described herein. For instance, while engine 33 of truck 30 provides the requisite power for mixing device 10 to mix ingredients (e.g., hay) by way of rotation of reel 13 and auger 14.

The combination of reel 13 and auger 14 provides for a high-efficiency mixing device. More specifically, as reel 13 rotates the blades of reel 13 mix the ingredients within mixing tank 11. In one embodiment, mixing device 10 is able to operate on 30 horsepower provided by truck 30.

Additionally, the rotation of reel 13 moves the ingredients towards the front of mixing tank 11. To counter-act the build-up of ingredients towards the front of mixing tank 11, the rotation of auger 14 moves the ingredients towards the back of mixing tank 11.

As reel 13 rotates within mixing tank 11, each of the paddles attached to the cutting blades also rotates within mixing tank 11. As the paddles rotate within mixing tank 11, the paddles sweep past opening 16. If door 15 is opened, the paddles force the ingredients out of mixing tank 11 through opening 16 and onto conveyer 17. Conveyor 17 then conveys the ingredients away from mixing tank 11.

For example, as truck 30 is travelling at a low rate of speed (e.g., ˜2-5 mph), door 15 is opened which enables the paddles to force the ingredient through opening 16 onto conveyor 17. The conveyor belt of conveyor 17 translates the ingredients away from mixing tank 11 and into a feeder.

It should be appreciated that mixing device 10 may be controlled via controller interface 18 located within cab 31. As such, a driver of truck 30 may control the functions of mixing device 10 while driving truck 30.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A hydraulically powered mixing device comprising:
a mixing tank configured to be mounted on a frame of a truck; and
a reel disposed inside said mixing tank and for mixing ingredients within said mixing tank, wherein said reel comprises:
a first helical blade continuously extending along a length of a first portion of said reel, and
a second helical blade continuously extending along a length of a second portion of said reel, wherein said first portion and said second portion are longitudinally offset from one another along said reel.

2. The hydraulically powered mixing device of claim 1, wherein said reel is hydraulically powered by a hydraulic pump that is attached to a power take-off of the automatic transmission with a live power take-off.

3. The hydraulically powered mixing device of claim 1, wherein said first helical blade comprises:
a paddle disposed at an end of said first helical blade, wherein said paddle is configured for pushing said ingredients through an opening of said mixing tank.

4. The hydraulically powered mixing device of claim 1, wherein said second helical blade comprises:
a paddle disposed at an end of said second helical blade, wherein said paddle is configured for pushing said ingredients through an opening of said mixing tank.

5. The hydraulically powered mixing device of claim 1, further comprising:
a plurality of helical blades continuously extending along said length of said first portion.

6. The hydraulically powered mixing device of claim 1, further comprising:
a plurality of helical blades continuously extending along said length of said second portion.

7. The hydraulically powered mixing device of claim 1, further comprising:
a hydraulically powered conveyor for conveying said ingredients away from said mixing tank.

8. The hydraulically powered mixing device of claim 1, further comprising:
a hydraulically powered door disposed on a side of said mixing tank for controlling outflow of said ingredients through an opening of said mixing tank.

9. The hydraulically powered mixing device of claim 1, further comprising:
a hydraulically powered auger disposed inside said mixing tank for moving said ingredients towards a back of said mixing tank.

10. The hydraulically powered mixing device of claim 1, further comprising:
a control interface for controlling said hydraulically powered mixing device from a cab of said truck.

11. A total mixed ration (TMR) mixing device comprising:
a mixing tank configured to be mounted on a frame of a truck; and
a horizontal reel for mixing ingredients within said mixing tank, wherein said reel comprises:
a first helical blade continuously extending from a first end of said reel to a discharge opening of said mixing tank, and
a second helical blade continuously extending from a second end of said reel to said discharge opening.

12. The TMR mixing device of claim 11, wherein said horizontal reel is hydraulically powered by a hydraulic pump that is attached to a power take-off of said truck.

13. The TMR mixing device of claim 11, further comprising:
an engine for powering said hydraulic pump.

14. The TMR mixing device of claim 11, wherein said first helical blade comprises:
a paddle disposed at an end of said first helical blade, wherein said paddle is for pushing said ingredients through said opening of said mixing tank.

15. The TMR mixing device of claim 11, wherein said second helical blade comprises:
a paddle disposed at an end of said second helical blade, wherein said paddle is for pushing said ingredients through said opening of said mixing tank.

16. The TMR mixing device of claim 11, further comprising:
a hydraulically powered auger disposed inside said mixing tank.

17. A mixing system comprising:
a straight truck comprising a frame; and
a hydraulically powered mixing device mounted on said frame, said hydraulically powered mixing device comprising:
a mixing tank; and
a horizontal reel for mixing ingredients within said mixing tank, wherein said reel comprises:
a first helical blade continuously extending from a first end of said reel to a discharge opening of said mixing tank, and
a second helical blade continuously extending from a second end of said reel to said discharge opening.

18. The mixing system of claim 17, wherein said first helical blade comprises:
a paddle disposed at an end of said first helical blade, wherein said paddle is for pushing said ingredients through an opening of said mixing tank.

19. The mixing system of claim 17, wherein said second helical blade comprises:
a paddle disposed at an end of said second helical blade, wherein said paddle is for pushing said ingredients through an opening of said mixing tank.

20. The mixing system of claim 17, further comprising:
a hydraulically powered auger disposed inside said mixing tank.
